(19) United States
(12) Patent Application Publication
(10) Pub. No.: US 2007/0234418 A1
(43) Pub. Date: Oct. 4, 2007

(54) Method and apparatus of remote access message differentiation in VPN endpoint routers

(75) Inventors: Yu Song, Pleasanton, CA (US); Phuong Nguyen, San Jose, CA (US); Alan Messer, Los Gatos, CA (US)

Correspondence Address: Kenneth L. Sherman, Esq.;Myers, Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/396,020

(22) Filed: Mar. 30, 2006

(51) Int. Cl. G06F 15/16

(52) U.S. Cl. 726/15

(57) ABSTRACT

Method and apparatus for remote access message differentiation in VPN endpoint routers enable differentiating local access traffic from remote traffic entering a network through a virtual private network (VPN), by allowing a local network router to treat and tag remote traffic differently from local traffic. Applications, such as HTTP server, benefit from such differentiation in order to respond differently to either remote or local access requests.

### FIELD OF THE INVENTION

The present invention relates to remote access message differentiation, and in particular to remote access message differentiation in virtual private network (VPN) endpoint routers.

### BACKGROUND OF THE INVENTION

A main purpose of virtual private network (VPN) is to provide secure access between a mobile device and a local network (e.g., home network, corporate network). Another purpose of VPN is to provide secure access between two local networks over unsecured, public Internet infrastructure.

In addition, VPN allows participating devices (e.g., mobile devices, devices in different local networks) to be subject to a set of security management, and quality of service (QoS) policies, that are applied to a true local network. In this sense, VPN strives to be transparent to participating devices such that devices are considered in a local, private network as oppose to being treated as on a public network.

There are essentially two types of VPN. The first type of VPN is remote access VPN, or virtual private dialup network (VPDN). The VPDN is deployed for individual remote users (e.g., mobile users). Software on the mobile device provides secure connection back to a user's local, private network. The second type VPN is the site-to-site VPN. The site-to-site VPN is deployed for interconnecting corporate sites.

In the remote access VPN, two solutions have been developed and deployed to solve the remote access to establish VPN. The first one is to use IPSec, which is a layer 3 solution in the OSI model, where IP packets are encapsulated with security information to guard against security attacks. The second solution is MPLS which is a layer 2.5 solution the OSI model because it is built between the data link layer technologies and layer 3 network technologies. MPLS, however, requires Internet service provider (ISP) core network to deploy MPLS-capable router for packet labeling and switching.

A mobile device being viewed as it is in a local network via VPN is, however, not always desirable. For example, when in a home, a mobile device can be used to stream pay-per-view content from the cable provider. However, due to DRM restriction, the per-per-view content may only be watched in a home, not outside the home environment. Such example illustrates that there is a need to differentiate a mobile device while in home and outside home.

There are few existing approaches that attempt to address this problem. The first approach is to use static IP address. This solution assigns each device a static IP address. For example, a mobile device is always assigned a static address such that it can be distinguished from other stationary devices. However, such an approach can only determine that a device is mobile, but it cannot distinguish whether the device is attached to a local network directly or via VPN. The result is that the device is subject to restrictions no matter where it is. In addition, this approach requires a home user to be familiar with network jargon in order to set-up devices to be functional.

Another approach has been to use Dynamic Host Configuration Protocol (DHCP) which automatically assigns an IP address to each device when it goes online. Because a DHCP server alone cannot distinguish a stationary device from a mobile device, additional steps must be performed. One method is to allocate a range of IP addresses dedicated for remote access. A pool of IP addresses is dedicated for those devices that establish a VPN connection with the router. This method allows a router to distinguish packets from a mobile device in VPN from packets from a device in the local network at the network layer. However, applications, for example a Web server, cannot distinguish the message unless the DHCP server contains an application programming interface (API) that allows applications to query whether an IP address is a remote or not. Another drawback of this approach is that the number of allowable mobile devices on a VPN is limited by the number of IP addresses allocated in the pool. As a result, if the number of mobile devices that wish to establish a VPN exceed the number of available IP addresses in the pool, some mobile device VPN connections cannot be established.

A third approach is a hybrid static IP and DHCP. The hybrid approach assigns static IP to stationary devices in a home network, and assigns dynamic IP addresses to mobile devices. This allows a router to distinguish a stationary device from a mobile device. However, this approach has the same drawback as the first approach above.

### BRIEF SUMMARY OF THE INVENTION

In one embodiment the present invention provides a method and apparatus for remote access message differentiation in VPN endpoint routers. This enables differentiating local access traffic from remote traffic entering the network through a virtual private network (VPN), by allowing a local network router to treat and tag remote traffic differently from local traffic. In addition, applications, such as HTTP server, can benefit from such differentiation in order to respond differently to either remote or local access requests.

VPN transparency may not always be desirable in a local network when security policies have different access controls for devices in a local network and devices over VPN. The present invention further allows a network device (e.g., router, appliance, etc.) to distinguish whether an incoming packet is from a remote mobile device via VPN, and allows applications to distinguish whether an incoming request is from a remote mobile device via VPN.

In one example, the present invention allows home networked devices to differentiate local accesses from remote ones in a virtual private network using VPN technologies. In contrast to existing approaches, the present invention provides differentiation at both network layer and application layer. The network layer differentiation allows a router to check and filter passing network packets with hardware speed. Network layer differentiation according to the present invention provides the ability to differentiate a mobile device location (i.e., outside local network vs. inside local network) without cumbersome task of dual DHCP servers setup. Further, differentiation on the application layer according to the present invention allows applications to distinguish remote access via VPN from access in a local network. This enables finer grained control access of service and content that is not possible with the conventional approaches.

These and other features, aspects and advantages of the present invention will become understood with reference to the following description, appended claims and accompanying figures.

### BRIEF DESCRIPTION OF THE DRAWINGS

FIG. 1 shows a functional block diagram of a network that embodies a remote access message differentiation method for VPN endpoint routers, according to an embodiment of the present invention.

FIG. 2 shows a flowchart of example steps of remote access message differentiation in VPN endpoint routers, embodied in the network of FIG. 1, according to an embodiment of the present invention.

FIG. 3 shows an example message packet with a flag in the IP option header for access message differentiation by checking/filtering in VPN endpoint routers, according to an embodiment of the present invention.

### DETAILED DESCRIPTION OF THE INVENTION

In one embodiment the present invention provides a method and apparatus for remote access message differentiation in VPN endpoint routers. This enables differentiating local access traffic from remote traffic entering the network through a virtual private network (VPN), by allowing a local network router to treat and tag remote traffic differently from local traffic. In addition, applications, such as HTTP server, can benefit from such differentiation in order to respond differently to either remote or local access requests.

VPN transparency may not always be desirable in a local network when security policies have different access controls for devices in a local network and devices over VPN. The present invention further allows a network device (e.g., router, appliance, etc.) to distinguish whether an incoming packet is from a remote mobile device via VPN, and allows applications to distinguish whether an incoming request is from a remote mobile device via VPN.

In one example, the present invention allows home networked devices to differentiate local accesses from remote ones in a virtual private network using VPN technologies. In contrast to existing approaches, the present invention provides differentiation at both network layer and application layer. The network layer differentiation allows a router to check and filter passing network packets with hardware speed. Network layer differentiation according to the present invention provides the ability to differentiate a mobile device location (i.e., outside local network vs. inside local network) without cumbersome task of dual DHCP servers setup.

Further, differentiation on the application layer according to the present invention allows application to distinguish remote access via VPN from access in a local network. This enables finer grained control access of service and content that is not possible with the conventional approaches.

Differentiating traffic between mobile devices via VPN, and devices inside a local network, allow finer access control of services and contents exposure inside a virtual private network. In the following three example implementations of said differentiation according to the present invention are described.

The first example implementation in an internet protocol (IP) environment involves a method that adds a flag at the network layer in an IP packet.

A local network router and other devices and applications in the local network can benefit from such differentiation. Adding the flag in the network packet allows the packet to be later checked (i.e., filtered) by devices in the local network for differentiating traffic between mobile devices via VPN, and devices inside a local network. For example, differentiation allows a router to filter traffic based on the traffic type (e.g., User Datagram Protocol (UDP) traffic, Transmission Control Protocol (TCP) traffic, etc.) and based on whether traffic is from a remote mobile device. In addition, the additional flag provides devices and applications inside the local network for finer grained filtering and generating proper responses based on the remote access policy.

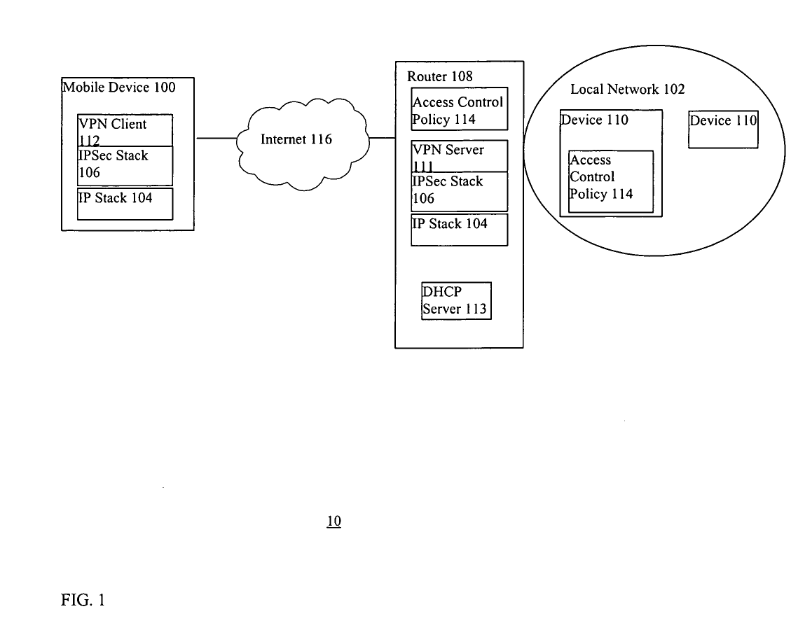

Referring to the functional block diagram in FIG. 1, a network 10 embodies the above implementation according to the present invention, using VPN via IPSec. Those skilled in the art will recognize other VPN technologies can also be used.

In the example of FIG. 1, a mobile device 100 is outside a local network 102. To communicate with devices 110 within the local network 102, the mobile device 100 includes a network stack comprising an IP stack 104, and a IPSec stack 106.

At the edge of the local network 102, a router 108 is responsible for routing IP packet flows between the mobile IP device 100 and devices 110 inside the network 102. The router 108 includes a network stack comprising IP stack 104, and IPSec stack 106. The router 108 also provides a DHCP service 113 that assigns IP addresses to devices, including devices 110 and the mobile device 100. A VPN client 112 operating in the mobile device 100, allows the mobile device 100 to setup the secured VPN connection to the local network 102. A VPN server 111 operating in the router 108 accepts requests from the VPN client 112 and establishes a VPN connection between the mobile device 100 and the local network 102. Both the router 108 and the local devices 110 may include access control policy 114. The access control policy 114 contains a database that details the policy for access level for remote/local access. For example, the access control policy 114 may indicate that remote devices are not able to output AV to local home devices, to prevent remote users upsetting those at home. The physical connection between the mobile device 100 and the router 108 is via the public, unsecured Internet 116.

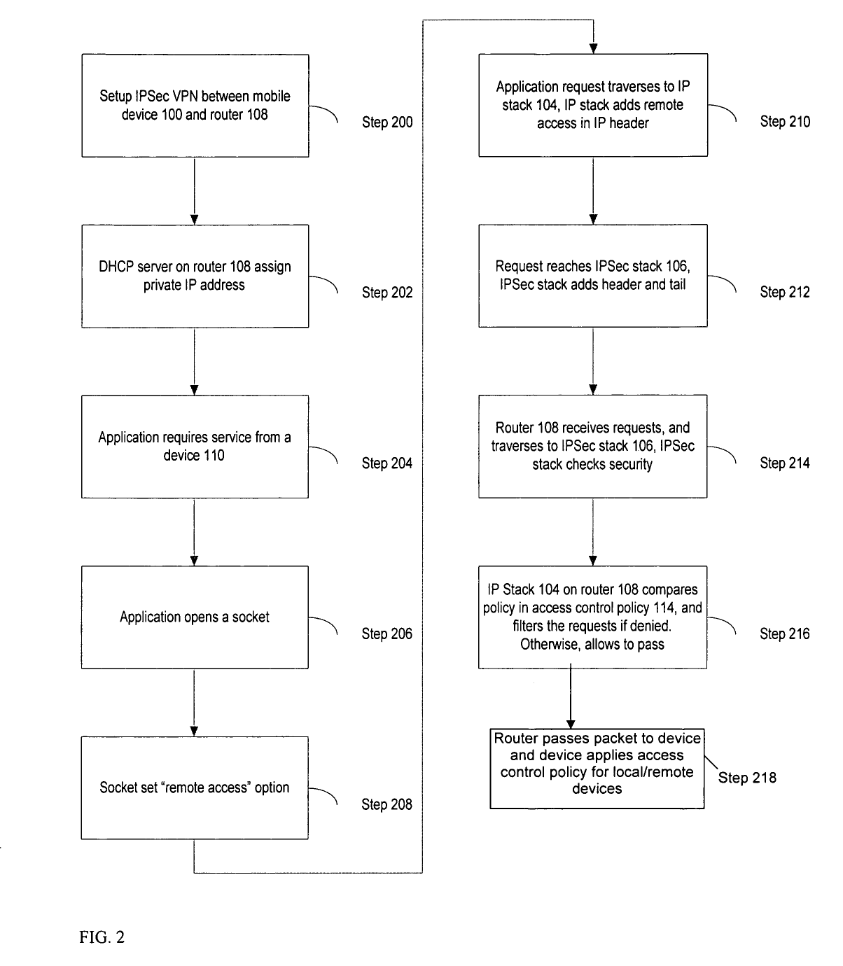

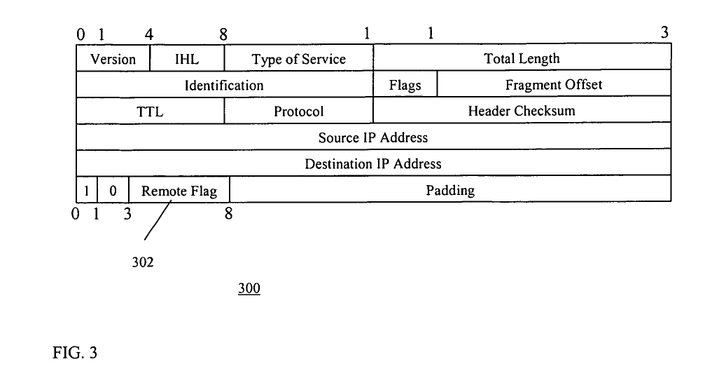

FIG. 2 shows a flowchart of example steps of remote access message differentiation in VPN endpoint routers, embodied in the network 10 of FIG. 1, according to the present invention, as follows:
In step 200, a user wants to connect to the local network 102 via VPN using the mobile device 100, wherein the VPN client 112 sets up VPN/IPSec with the VPN server 111 in the router 108.
In step 202, once the VPN is setup, the DHCP service 113 of the router 108 assigns a private network IP address to the mobile device 100.
In step 204, the user starts an application on the mobile device 100 which requires services from a device 110 in the local network 102.
In step 206, the application opens a socket interface that connects on the device 100.
In step 208, the socket internally queries the IPSec 106 in device 100 to determine if the socket is on the IPSec 106. If it is on the IPSec 106, the socket sets a “remote access” option flag to true. This flag can be queried by the application on the socket (e.g., using getsockopt in Unix API).
In step 210, the application in device 100 sends a request to device 110 via the socket as follows. The request is placed in a packet that first traverses into the IP stack 104 of device 100. As shown in the example of FIG. 3 illustrating a packet header, the IP stack 104 adds a remote flag 302 in the IP option header of request packet (message) 300.
In step 212, the request then traverses to the IPSec stack 106 of device 100. The IPSec 106 adds its own header and tails to the IP packets.
In step 214, eventually, the request is sent from the mobile device 100 to the router 108. The request traverses upwards to the IPSec stack 106 of the router 108. The IPSec stack 106 of the router 108 performs security and integrity check on the request, and passes the request to the IP stack 104 of the router 108.
In step 216, the IP stack 104 of the router 108 examines the IP header of the request packet, and compares it with the access control policy 114. The policy states that a request should be dropped if it comes from a remote device and is of type of TCP. In this example, because the request has the option header set to be remote, and it is a TCP packet, the router 108 drops the request. Otherwise, the request would be allowed to pass to the intended device 110.
In step 218, if the device 110 receives a checked request from the router 108, the device 110 examines the IP header of the request and compares it with the access control policy 114. The policy allows the user to set different levels of operation for remote device access and local device access.

The second aforementioned example implementation according to the present invention involves differentiation of messages from a remote device via VPN from messages from a locally networked device by assigning mobile device VPN IP address to a “blacklist”. A router contains an application programming interface (API) such that applications and devices inside a local network can query whether a specific message comes from a mobile device or not.

The third aforementioned example implementation according to the present invention involves differentiation of messages from a remote device via VPN from messages from a locally networked device using “blacklist” approach. The home router that contains IPSec stack includes a list of devices that is remote device via VPN. The router can distinguish such devices in the IP layer. When an incoming message from a remote device arrives, the router's IP/IPSec stack examines the message IP packet. If the router determines that the message comes from a remote device, the router adds the VPN-masked IP address of the remote device to the “blacklist”. If the same address is assigned to a new locally accessible device, the router removes the IP address from the blacklist. The router provides two interfaces for other devices in the network. The first interface allows a device to obtain a complete list of IP addresses that are assigned to remote devices. The second interface allows a device to query whether a specific IP address is assigned to a remote device. These two interfaces enable other devices in the device to different messages and do the appropriate filtering and responds accordingly.

The description of example embodiments herein focuses on the remote access VPN due to interest in remote access to a home network as opposed to corporate network. However, as those skilled in the art will recognize, the present invention is equally applicable to other networks such as site-to-site corporate networks, home-to-home networks and etc. In addition, the present invention adds very little overhead at network layer and application level, and is fully compatible with existing standards.

While the present invention is susceptible of embodiments in many different forms, these are shown in the drawings and herein described in detail, preferred embodiments of the invention with the understanding that this description is to be considered as an exemplification of the principles of the invention and is not intended to limit the broad aspects of the invention to the embodiments illustrated. The aforementioned example architectures above according to the present invention can be implemented in many ways, such as program instructions for execution by a processor, as logic circuits, as ASIC, as firmware, etc., as is known to those skilled in the art. Therefore, the present invention is not limited to the example embodiments described herein.

The present invention has been described in considerable detail with reference to certain preferred versions thereof; however, other versions are possible. Therefore, the spirit and scope of the appended claims should not be limited to the description of the preferred versions contained herein.

What is claimed is:

1. A method of managing communications in a virtual private network, comprising the steps of:
differentiating local access communications from remote access communications entering the local network; and
treating remote access communications differently from local access communications.

2. The method of claim 1 wherein the virtual private network is connected via a local network router such that the step of differentiating is performed by the router.

3. The method of claim 2 wherein the router comprises a VPN endpoint router.

4. The method of claim 1 wherein the step of differentiating further includes the steps of:
differentiating local access communications from remote access communications entering the local network by checking incoming communication packets at the network layer.

5. The method of claim 4 wherein the step of differentiating further includes the steps of:
differentiating a mobile device traffic source as within the local network or outside the local network.

6. The method of claim 1 wherein the step of differentiating further includes the steps of:
differentiating local access communications from remote access communications entering the local network by checking incoming communication packets at the application layer.

7. The method of claim 6 wherein the step of differentiating further includes the steps of:
differentiating local access communications from remote access communications entering the local network by checking incoming communication packets at the application layer to distinguish remote access via the virtual private network from access in a local network.

8. The method of claim 1 wherein the steps of differentiating includes the steps of:
differentiating local access communications from remote access communications entering the local network.

9. A method of managing communications in a virtual private network, comprising the steps of:
generating a message communication including a remote access identifier;
transmitting the message communication to the local network;
receiving the message communication and checking the remote access identifier; and
differentiating local access communications from remote access communications entering the local network based on the remote access identifier.

10. The method of claim 9 wherein the virtual private network is connected via a local router such that the step of differentiating is performed by the router.

11. The method of claim 10 wherein the router comprises a VPN endpoint router.

12. The method of claim 9 wherein the step of differentiating further includes the steps of:
differentiating local access communications from remote access communications entering the local network by checking incoming communication packets at the network layer.

13. The method of claim 12 wherein the step of differentiating further includes the steps of:
differentiating a mobile device traffic source as within the local network or outside the local network.

14. The method of claim 9 wherein the step of differentiating further includes the steps of:
differentiating local access communications from remote access communications entering the local network by checking incoming communication packets at the application layer.

15. The method of claim 14 wherein the step of differentiating further includes the steps of:
differentiating local access communications from remote access communications entering the local network by checking incoming communication packets at the application layer to distinguish remote access via the virtual private network from access in a local network.

16. The method of claim 9 wherein the steps of differentiating includes the steps of:
differentiating local access communications from remote access communications entering the local network.

17. A virtual private communications network comprising:
a local network connected to an access controller that differentiates local access communications from remote access communications entering the local network.

18. The virtual private communications network of claim 19 wherein the access controller comprises a VPN endpoint router.

19. The virtual private communications network of claim 18 wherein the router differentiates local access communications from remote access communications entering the local network by checking incoming communication packets at the network layer.

20. The virtual private communications network of claim 19 wherein the router differentiates a mobile device traffic source as within the local network or outside the local network.

21. The virtual private communications network of claim 18 wherein the router differentiates local access communications from remote access communications entering the local network by checking incoming communication packets at the application layer.

22. The virtual private communications network of claim 18 wherein the router differentiates local access communications from remote access communications entering the local network by checking incoming communication packets at the application layer to distinguish remote access via the local network from access in a local network.

23. The virtual private communications network of claim 17 further comprising a device connected to the router via communication link, wherein the device generates a message communication including a remote access identifier and transmits the message communication to the local network, such that upon receiving the message communication, the access controller checks the remote access identifier, and differentiates local access communications from remote access communications entering the local network based on the remote access identifier.
